(19) United States
(12) Patent Application Publication
(10) Pub. No.: US 2020/0226610 A1
(43) Pub. Date: Jul. 16, 2020

(54) Fingerprint Verification System for Financial Transactions

(71) Applicant: Frank Hutton, Brooklyn, NY (US)

(72) Inventor: Frank Hutton, Brooklyn, NY (US)

(21) Appl. No.: 16/249,738

(22) Filed: Jan. 16, 2019

(51) Int. Cl. G06Q 20/40; G06K 9/00; G06Q 20/34; G07F 19/00; G06Q 20/20

(52) U.S. Cl. CPC G06Q 20/40145; G06K 9/00087; G06Q 20/409; G07F 19/206; G06Q 20/206; G06Q 20/34

(57) ABSTRACT

A fingerprint verification system for financial transactions is disclosed. The system having three main parts. A first part being a payment card—such as an automatic teller machine (ATM) card, credit card anti debit card etc. with onboard memory chip; a second part being cloud-based, fingerprint recognition software; and a third part being a capacitive touch screen. The system being configured for three main financial transactions. A first transaction being between a customer and an ATM; a second transaction being between a customer and an online vendor, a third transaction being between a customer and a brick-and-mortar retail outlet, in all transactions, the customer presents a card that interacts with the software prompting the customer to reveal their fingerprint on the capacitive touch screen. If the fingerprint matches the print in the software the transaction is allowed to continue. If there is no match the transaction is cancelled.

### CROSS-REFERENCE TO RELATED APPLICATIONS

This application claims cite benefit of U.S. Provisional Patent Application No. 62/619,859, filed on Jan. 21, 2018.

### FIELD OF THE INVENTION

The present invention relates generally to financial transaction security. More particularly, it relates to a fingerprint security system for financial transactions.

### BACKGROUND OF THE INVENTION

Payment cards and credit cards have been extremely popular over the last several decades and many consumers prefer to carry them rather than carrying cash. It is easy to see why they are so popular—users can withdraw cash from local ATM terminals or even from terminals located in other countries due to the global financial connectivity that is available. However, illegal use of such cards by nefarious individuals has become a widening problem and can result in monetary losses to both users as well as financial institutions. Once a thief has another user's card, the signature is easily imitated and most merchants don't bother determining whether or not the cardholder is actually the registered owner of the card. In addition, as more and mom people, conduct business transactions over die internet there is a need for enhancing security and personal identification when using such cards.

Biometrics is quickly becoming a popular means to enhance the security of payment cards. These non-transferable unique biometric characteristics include capturing a customer's DNA, iris of the eye, fingerprints, face and voice patterns. Facial recognition, DNA and the iris of the eye perform verification with very high reliability; however, these technologies are very expensive. Fingerprint verification is much less memory-intensive and current digital capture mechanisms are an affordable option to minimize payment card fraud. United States Patent No. 20020163421A1 for ATMs print is stored on the card; U.S. Pat. No. 5,623,552A onboard fingerprint sensor on the card; U.S. Pat. No. 8,276,816B2 smart card with embedded fingerprint sensor; United States Patent No. 20020087869A1 smart card verification unit with external fingerprint reader; U.S. Pat. No. 6,325,285B1 smart card with embedded fingerprint sensor. A majority of the patents found incorporate the fingerprint within the card itself and do not verify die user's fingerprint in real time at the point of bank and online transactions.

### SUMMARY OF THE INVENTION

A fingerprint verification system for financial transactions is disclosed. An object of die invention is to enhance payment card security. When a user initiates a transaction using the invention, die system requires them to provide a fingerprint immediately on a touch screen (part of the invention) to complete a transaction. If a fingerprint cannot be verified, a user is restricted from completing the transaction.

The bank card may comprise a chip imbedded into the card in a similar fashion to that of a conventional bank card chip of an Europay, Mastercard and Visa (EMV) card. The chip of the payment card may store digitally mastered fingerprint. A user may provide a digitally mastered fingerprint via the fingerprint identification software which may record and store a fingerprint pattern for a financial institution. Multiple fingerprints corresponding to a financial account may be stored via the fingerprint identification software, such that multiple bank account holders may have access to an account. The fingerprint identification software may comprise software which may capture and verify a fingerprint pattern via a touch screen. The fingerprint identification software may be provided on an ATM, an electronic device of a financial institution, a computer screen, and other electronic devices having touch screen capabilities. The present invention may be used for financial transactions at an ATM, online purchasing, and point of sale purchasing at businesses.

A method of use of the present invention for an ATM may comprise: inserting the bank card into the ATM, depressing a finger onto a touch screen of the ATM within a displayed area within 15 seconds, identifying a green check mark if the fingerprint is accepted or alternatively identifying a red check mark if a fingerprint is denied, accessing a financial account if accepted, reattempting up to two more attempts if denied. A method of use of die present invention for an online purchases may comprise: entering the bank card number and pertinent financial information into a point of sale on a website, depressing a finger onto a touch screen of a computer or other electronic device within a displayed area within 15 seconds, identifying a green check mark if the fingerprint is accepted or alternatively identifying a red check mark if a fingerprint is denied, completing an online purchase or other online financial transaction, reattempting up to two more attempts if denied.

A method of use of the present invention for a retail purchase or other point of sale purchase may comprise: entering the bank card into a point of sale device, depressing a finger onto a touch screen of a point of sale device within a displayed area within 15 seconds, identifying a green check mark if the fingerprint is accepted or alternatively identifying a red check mark if a fingerprint is denied, completing a point of sale purchase or other financial transaction, reattempting up to two more attempts if denied.

The embodiments of die invention described herein are exemplary and numerous modifications, variations and rearrangements can be readily envisioned to achieve substantially equivalent results, all of which are intended to be embraced within the spirit and scope of the invention. Further, the purpose of die foregoing abstract is to enable the U.S. Patent and Trademark Office and die public generally, and especially the scientist, engineers and practitioners in die art who are not familiar with patent or legal terms or phraseology, to determine quickly from a cursory inspection die nature and essence of the technical disclosure of the application.

### BRIEF DESCRIPTION OF THE DRAWINGS

FIG. 1 is a perspective view of an ATM transaction embodiment

FIG. 2 is a perspective view of an online transaction embodiment.

FIG. 3 is a perspective view of a retail transaction embodiment.

FIG. 4 is a representative view of the invention process.

Other aspects of the present: invention shall be more readily understood when considered in conjunction with the accompanying drawings, and the following detailed description, neither of which should be considered limiting.

### DETAIL DESCRIPTION OF THE INVENTION

In this description, the directional prepositions of up, upwardly, down, downwardly, front, back, top, upper, bottom, lower, left, right and other such terms refer to the device as it is oriented and appears in die drawings and are used for convenience only; they are not intended to be limiting or to imply that the device has to be used or positioned in any particular orientation. AD illustrations of the drawings are for the purpose of describing selected versions of the present invention and are not intended to limit the scope of die present invention.

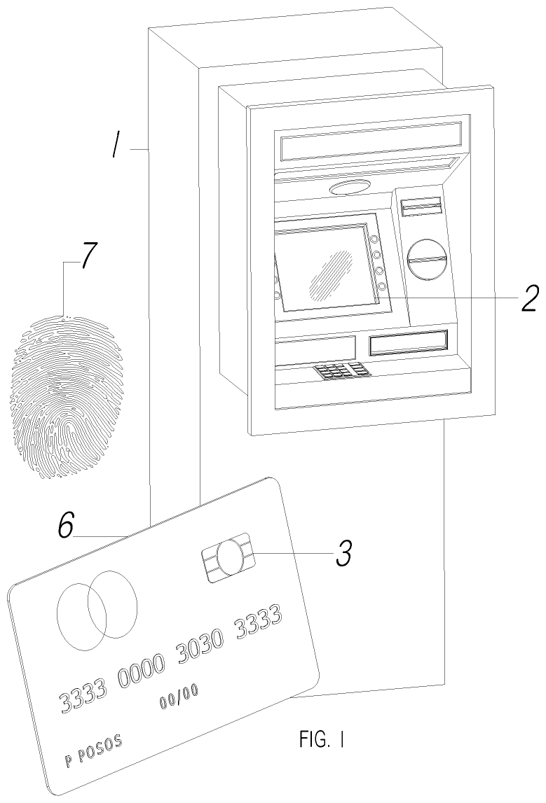

The system having three main parts. A first part being a payment card 6—such as an automatic teller machine (ATM) card, credit card and debit card etc. with onboard memory chip; a second part being cloud-based, fingerprint recognition software; and a third part being a touch screen. FIG. 1 showing a perspective view of an ATM 1 embodiment of the invention. The invention being compatible with a multitude of ATMs including but not limited to: on site ATM (within the premises of a bank); off site ATM (outside the bank premises); worksite ATM (located within the premises of an organization and is generally meant only for the employees of the organization); cash dispenser (allows only cash withdrawal, balance inquiry and mini statement requests, cash dispenser); mobile ATM (an ATM that moves in various areas for the customers); white label ATM (provided by non banking financial company); green label ATM (provided for agricultural transactions); orange label ATM (provided for share transactions); yellow label ATM (provided for e-commerce); and pink label ATM (women banking). The invention being compatible with a plurality of payment cards 6 such as but not limited to: credit cards, debit cards, charge cards, ATM cards, stored-value cards, fleet cards and the like. A user being required to insert said payment card 6 into die conventional ATM 1 slot thereby triggering communication between the bank and the invention's cloud network for authorization and verification of identity before being allowed to issue transactional commands to the ATM 1 thereon. The aforementioned payment card 6 having a user's account information stored therein triggering commands from the bank's existing network.

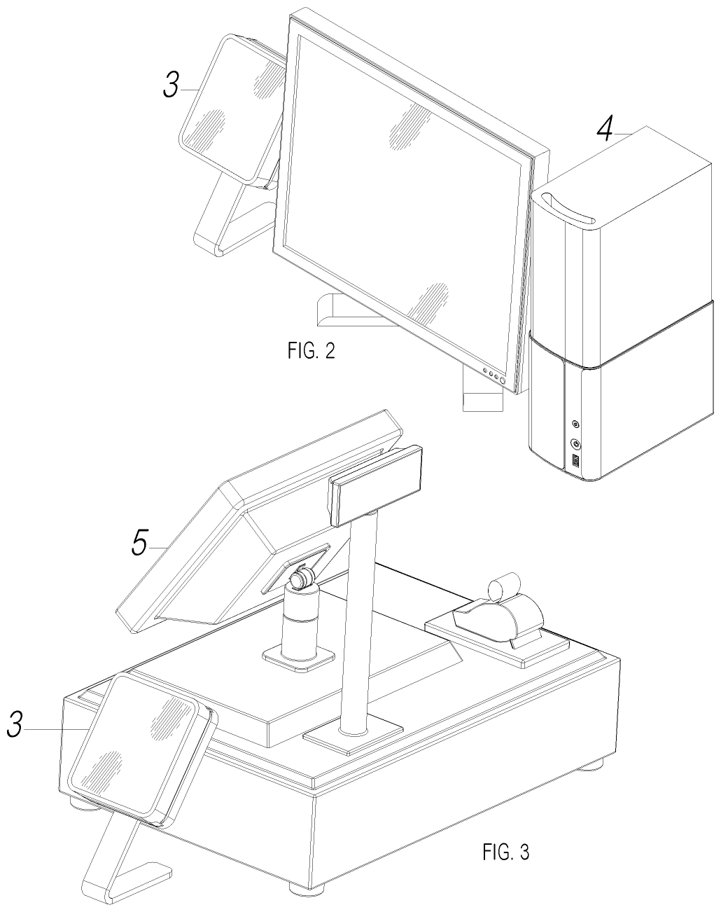

FIGS. 2 and 3 are perspective views of two embodiments of the invention. A first embodiment in FIG. 2 being a personal computer 4. The invention having software downloaded by a user to their computing device. The abovementioned invention software being written from code that may include, but not be limited to: Java, C++, Visual basic, Fortran, Basic and the like. The software also compatible with a plurality of operating systems such as, but not limited to: Windows, Apple and Android and compatible with a multitude of hardware platforms such as, but not limited to: personal desktops, laptops, tablets, smartphones and the like. FIG. 3 showing (lie invention used in conjunction with conventional, cash register terminals 5 such as but not limited to computerized point of sale systems, mobile point of sale technologies, and self checkout and the like. The embodiments shown in FIG. 2 and FIG. 3 having touch screen 3 as part of the system being composed of, but not limited to: optical sensors (capturing the image of fingerprints with a specialized digital camera setup); capacitive scanners; ultrasound sensors; ultrasonic sensors; and thermal line sensors etc. capturing a user's finger prints 7 and generating a digital image therein. The software also having the option to turn any computer screen into a touch screen to allow fingerprint entry by means of a ‘Human Interlace Devices’ option.

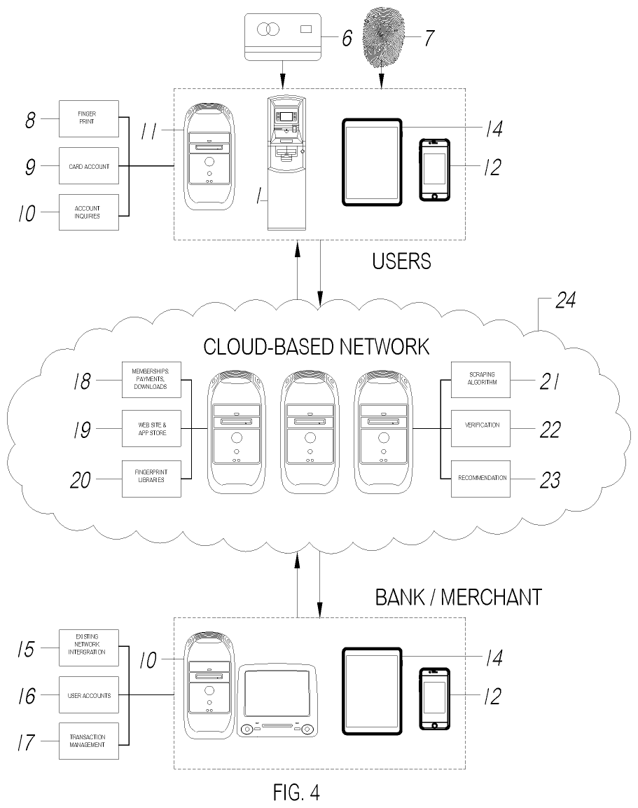

FIG. 4 showing the invention process. A user furnishing their payment card 6 and finger print to a multitude of input devices such as, but not limited to personal computer 11, ATM 1, tablet 14 and smartphone 12. The user issuing commands that include but are not limited to: fingerprint type 8, payment card account requests 9 (cancellation, new account) and account inquiries 10 (balance, withdrawal, deposit etc.). The figure also showing bank inputs and outputs by means of desktop computers 10, tablets 14 and mobile computing devices 12. The invention integrating with the bank's existing network 15 linking user accounts 16 and performing transaction management routines 17 in concert, with the invention. FIG. 4 showing both the user and the bank sending and receiving account and security information to and from the invention's cloud-based network 24. Said cloud-based network 24 having a plurality of algorithms such as, but not limited to: stakeholder membership payments and software downloads 18; website and mobile device application management routines 19, payment card holder fingerprint library files 20, scraping algorithm 21 that searches fingerprint databases for card holder matches; card holder verification notifications 22; and final verification recommendations 23 to financial institutions in real-time.

It is additionally noted and anticipated that although die device is shown in its most simple form, various components and aspects of die device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A payment card security system comprised of the following parts:
a.) a payment card;
b.) a software program;
c.) a touch screen;
d.) a receiving terminal; and
e.) a cloud network.

2. The payment card of claim 1 also having a user's account information stored therein.

3. The software program of claim 1 also being compatible with user's existing computing devices and compatible with financial institutions existing account networks.

4. The receiving terminals of claim 1 including but not limited to ATMs, personal computers, and mobile devices etc.

5. A method of payment card security comprising:
a.) providing a fingerprint;
b.) matching a payment card holder's fingerprint;
c.) verifying a payment card holder's fingerprint; and
d.) transmitting verification to stakeholders.

6. The transmitting of method of claim 4 further comprising a means to either allow or restrict access to a financial transaction request.
